(19) United States
(12) Patent Application Publication
(10) Pub. No.: US 2012/0025021 A1
(43) Pub. Date: Feb. 2, 2012

(54) PAYLOAD DOOR AND ELEVATOR SYSTEM

(76) Inventors: James Jorgensen, San Diego, CA (US); Scott Campbell, San Diego, CA (US)

(21) Appl. No.: 13/185,399

(22) Filed: Jul. 18, 2011

Related U.S. Application Data
(60) Provisional application No. 61/364,963, filed on Jul. 16, 2010.

(51) Int. Cl. B64C 1/14; B64D 47/08; B64C 7/00

(52) U.S. Cl. 244/129.4

(57) ABSTRACT

A payload door and elevator system for the translation of a payload such as a camera, from a stowed position within an aircraft fuselage to a deployed position projecting through an aperture formed in the wall of the fuselage. The system employs a translation component engaged to vertically translate the payload and operatively positioned inline with the aperture. Payload doors sealing the aperture horizontally translate in opposing directions once vertically translated from sealed engagement with the aperture. The horizontal translation alleviates much of the stress imparted to doors on aircraft which move to vertical positions in or extending from the aperture in the fuselage.

This application claims priority to U.S. Provisional Application Ser. No. 61/364963, filed on Jul. 16, 2010, and is incorporated in its entirety by reference herein.

### BACKGROUND OF THE INVENTION

1. Field of the Invention

The disclosed device relates to aircraft bay elevator systems. More specifically, to a system and method for deploying a payload, which employs doors, which translate and retract into the fuselage, and a payload translation system employing a non-cantilevered elevator design which symmetrically supports the payload at both ends.

2. Prior Art

National security has become more important since the events of 9/11. Many measures in ensuring safety have been employed such as increased border and air traffic security, weapons detection and recovery, as well as enemy surveillance and many others. Surveillance, especially that done by aircraft, effectively scouts dangerous territory and with the assistance of unmanned areal vehicles, can reduce the possible loss of life to zero. Aside from security reasons, aircraft surveillance can also be used for land mapping as well as many other purposes.

Aerial surveillance more than often requires a camera of some sort to be mounted to the underbelly of an aircraft. Although a rigidly engaged camera may suffice for such purposes, in an effort to maintain aerodynamic properties of an aircraft as well as uphold stealth capabilities of the aircraft, it is often more desirable to vertically translate such a device through a bombay door opening on the aircraft. Such a process is best accomplished through an elevator payload mechanism.

Conventional payload elevators are generally of a cantilevered design where the payload is supported at one end of a mounting plate by two linear shafts. The payload is actuated by two motors connected to a single ball screw centered between the two linear shafts, also at one end of the payload mounting plate.

In such designs, with support only provided at one end, the mounted payload of this type is sensitive to vibration, especially when deployed at high airspeeds. Consequently, this requires the mounting structure to be of high strength and stiffness. This increases weight and deployment times and has other disadvantages.

Additionally, conventional payload door assemblies generally employ cantilevered doors which must be deployed into the airstream below or around the fuselage. Further, most payload doors are located in a negative pressure area on the fuselage. This causes the local pressure to try and pull the doors of the assembly away from or out of the fuselage. Deployment and retraction of conventional cantilevered doors, into this high speed airstream with negative pressure, also requires great strength to the supporting structures and power sufficient to overcome the airstream and negative pressure in order to open and close the doors. The deployed doors in the high speed airstream can also cause problems by redirecting the moving air into the payload.

As such, there exists an unmet need for both a payload deployment system which supports and drives the payload during both deployment and retraction. An additional need is unmet for payload doors which need not be deployed to the exterior of the fuselage into the high speed airstream and negative pressure.

U.S. Pat. No. 5,938,382 to Andre et. al. teaches a load bearing elevator for translation in two dimensions. The device is driven by two screw actuators at opposite edges of a mounting plate. The device, however, does not offer support on the corners of the mounting plate as would be needed to prevent tilting or jamming.

U.S. Pat. No. 457,645 to Hancock teaches an elevator with screw actuators on all four corners of a mounting plate which better acts to alleviate jamming. However, the device will require higher precision mounting and assembly as well as possibly higher power output driving motors at each corner which can be costly and quite bulky.

U.S. Pat. No. 6,454,208 to Nervig et. al. teaches a galley-cart storage system where a cart elevator located within a container is used to lift and lower pallets vertically through a passage. The elevator, having four linear bushings riding on four shafts at each corner of a payload mounting plate and driven by lead screws positioned at opposite edges of the payload plate, however further alleviating the possibility of jamming, does not meet the robust requirements needed to withstand forces experienced external of a moving aircraft.

As such, the need remains unmet for an improved payload deployment system providing support and power to drive the payload during both deployment and retraction positions and for payload doors which need not be deployed to the exterior of the fuselage into the high speed airstream and negative pressure.

### SUMMARY OF THE INVENTION

The device and system herein provides a solution to the above noted shortcomings in the prior art. For payload deployment and retraction, the disclosed system provides a means to translate a payload from the interior to the exterior of an aircraft in a manner to avoid jamming or tilting. The disclosed device is comprised of a core structural member as well as mounting plate member and actuator. The core structural member is composed of a top and bottom plate of similar rectangular size and construction rigidly engaged on all four corners via vertical shaft members. The top plate houses electronics as well as driving motors which will be described shortly. The bottom plate is composed of merely four walls constructed into a rectangular shape with a void in the center. The shafts are engaged to either plate via set screw or other means of engagement. The mounting plate member is used to secure and mount a payload and is also of similar size and construction of the top and bottom members. The mounting plate member is positioned between the top and bottom plates and is engaged to the vertical shaft members also at each of its corners, via sliding bushings. The sliding bushings allow for translation only along the axial direction of the shaft members connecting the top and bottom plate members.

The active translation of the mounting plate member about the axial direction of the shaft members is done via a screw type actuator located centrally on two opposite edges of the device. Each of the two actuators is engaged semi-rigidly to the bottom plate member allowing only rotational motion. Similarly, the engagement to the top plate member is also semi-rigid allowing only rotational motion and is also connected via worm gears to a driving motor located on the top plate member as well. Each screw actuator however, passes through a transfer screw engaged rigidly to the mounting plate member. As the actuator screw is rotated, the rotary motion is transferred to axial translation of the mounting plate member via the transfer screw causing motion of the mounting plate and bushings about the support shaft members relative to the rigidly engaged top and bottom plate members. The bushings, transfer screw, and other translating members are of such material composition as to reduce friction, such as but not limited to Teflon.

Encompassing the four support shafts about all corners, as well as the symmetric screws actuator configuration, the current invention is able to translate a payload securely and without jamming.

The payload door assembly portion of the system employs two door carriage assemblies, two actuator assemblies and a drive motor assembly. As disclosed herein, the payload door overcomes the negative pressure issues noted above using doors which are spring loaded, and which during deployment, pull into the fuselage rather than being deployed in the high speed airstream.

In operation, a drive motor turns a drive shaft with a pulley and the drive shaft powers two 90 degree gearboxes on an actuator assembly. Each actuator assembly is compromised of a 90 degree bevel gear box, a left and right hand ACME screw thread, two shaft couplers and a roller bearing.

The door carriage assemblies have the mating ACME nut, linear guide bearing and the door assembly. The door assembly has the door carriage, three hinge assemblies and the door half.

Each hinge assembly is a four-bar mechanism with a helical torsion spring which provides sufficient force to overcome the local negative pressure and to translate the doors up into the fuselage.

In use, once a door-opening command is given, power is provided to the drive motor which turns the ACME screw threads causing the door carriages to move apart. As the carriages move apart, springs provide a bias to pull the door halves up into the fuselage. The door continues to draw up into the fuselage until the hinges to which they are engaged, reach a maximum travel, where after the door separates into two halves which continue to open until they reach their stop.

During closing of the door, the drive motor is run in the reverse directions causing the two door halves to converge until they make contact. Once the door halves make contact with each other, the additional travel of the door carriage pushes the door halves downward into the opening in the fuselage to close the opening in the fuselage.

Thus the payload is well supported during deployment and retraction, and the doors providing deployment into the airstream are retracted into the fuselage out of the high speed airstream.

With respect to the above description, it is to be understood that the invention is not limited in its application to the details of operation of the device nor the arrangement of the components or steps in the method set forth above or in the following descriptions or in the illustrations in the drawings. The various methods of implementation and operation of the disclosed device herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefor, those skilled in the art will appreciate that the conception upon which this disclosure is based may readily be utilized as a basis for designing similar devices for carrying out the several purposes of the present invention. Therefor, the objects and claims herein should be regarded as including such equivalent constructions, steps, and methodology insofar as they do not depart from the spirit and scope of the present invention.

It is an object of this invention to provide a means to translate a payload secured to a mounting surface.

It is yet another object of the invention to translate such a payload in a manner to avoid jamming and to assure continuous motion during translation.

It is still yet another object of the invention to provide such translation by means of actuating screws arranged in a symmetric fashion.

It is yet another object of this invention to provide a payload door which retracts into the fuselage rather than deploying outward into the high speed airstream and negative pressure surrounding the fuselage.

### BRIEF DESCRIPTION OF THE FIGURES

FIG. 1 depicts an isometric view of the device for deployment and retraction of the payload.

FIG. 2 shows a top view of FIG. 1, and the motor powering deployment and retraction.

FIG. 3 is a side view of FIG. 1 showing the two positions of the turret interface employed for deployment and a stowed or retracted position.

FIG. 4 is a perspective view of a camera turret attached to the device of FIG. 1 and stowed.

FIG. 5 depicts an exploded view of a half section of the payload door and the biasing springs.

FIG. 6 depicts the motor providing power to open the payload doors and close them.

FIGS. 7-11 depict the sequence of the payload door moving from a flush closed position to and open position and back again during a deployment of the payload.

### DETAILED DESCRIPTION OF THE PREFERRED EMBODIMENTS OF THE DEVICE

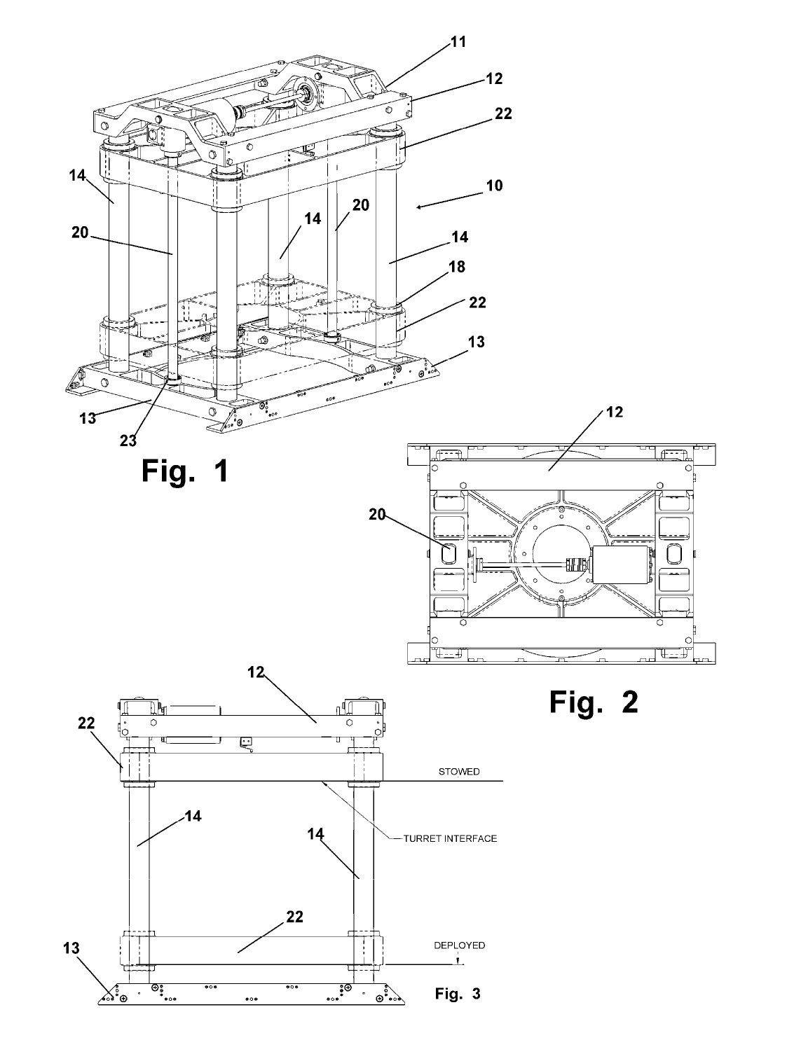

Now referring to drawings in FIGS. 1-11, wherein similar components are identified by like reference numerals, there is seen in FIG. 1 an embodiment of the invention 10 depicting the payload translation component 11 and showing the engagement of a payload 16, such as a rotatable camera, to the mounting plate 22. The members forming the support shafts 14 are positioned at the corners of the top 12 and bottom 13 plates and are rigidly engaged to the top 12 and bottom 13 plates respectively.

The translatable mounting plate member 22 is positioned between the top 12 and bottom 13 plates and engaged via sliding bushings 18 to a translatable engagement to the support shafts 14. These bushings 18 allow for translation only along the axial direction of the support shafts 14.

The lead actuating screws 20, such as worm gears, are positioned symmetrically for rotational engagement between the opposite edges of the top 12 and bottom 13 plates and are engaged on either plate by a means to allow for rotational motion only. The mounting plate 22 is operatively engaged to the actuating screws 20 at the transfer screw 23 engagement which is adapted to engage with the actuating screws 20 and to transfer the rotational motion of the actuating screws 20 and convert it to translating vertical motion of the mounting plate 22.

Driving motors (not shown) located within the electronics housing area 21 on the top plate 12 are operatively engaged to and rotate the actuator screws 20 via a secondary worm gear (not shown) and thereby rotate the actuator screws 20 causing the transfer screw 23 and mounting plate 22 to translate in either direction along the axis of the actuator screws 20 and support shafts 14, depending on the direction of rotation imparted to the actuator screws 20 by the motor.

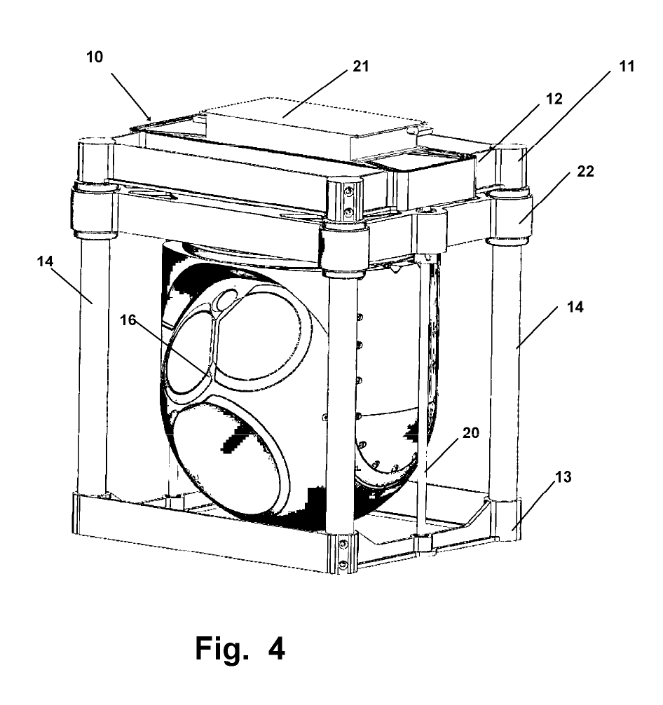

In the as-used position, with the payload translation component 11 operatively mounted within the fuselage 38 and aligned with the aperture 31 (FIG. 9), as the mounting plate 22 is translated toward the bottom plate 13 the payload 16, shown as a camera, passes through an aperture in the bottom plate 13 and is eventually exposed below the bottom plate 13. Reversing the rotation of the motor and engaged actuator screws 20 reverses this action and raises the payload 16 to the stowed position of FIG. 4.

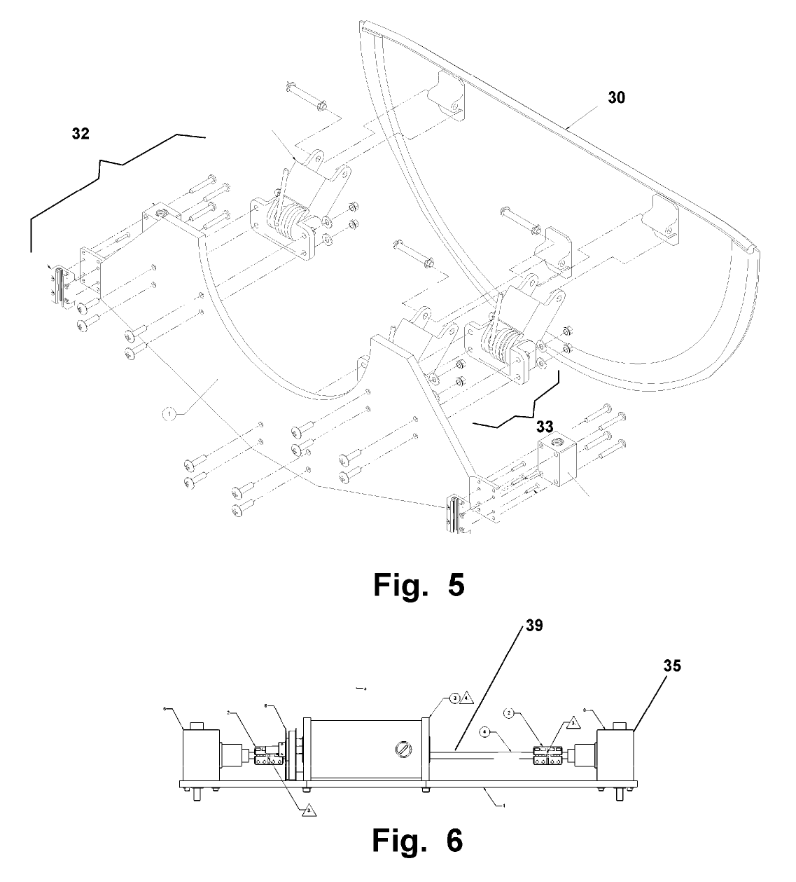

In FIG. 5 is shown the above described payload door 30 in a half section assembly and the motor powered actuator assembly 32 providing the deployment thereof using the engaged motor drive assembly 35 in FIG. 6. The payload door 30 itself features two door carriage assemblies 33, two actuator assemblies 32 and a drive motor assembly 35.

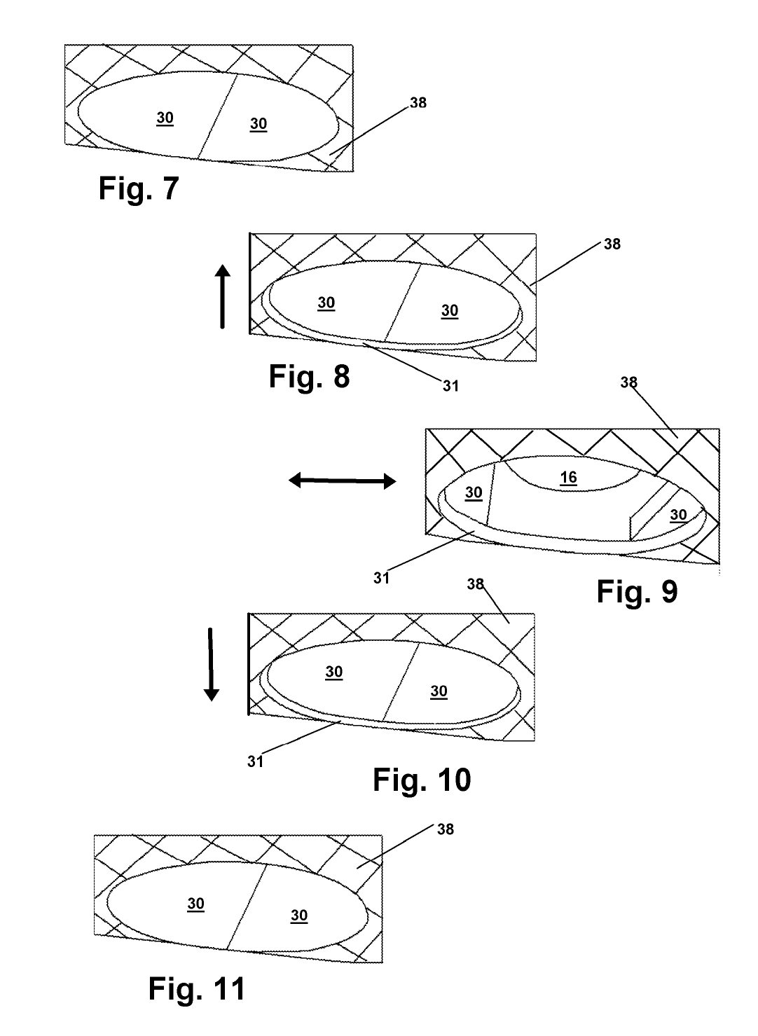

As already noted above, in the current configuration, the payload door 30 halves forming the door within the aperture 31 in the fuselage 38 overcome the prior art problems of rotating the door 30 halves to extend from the aperture 31 and below the fuselage 38. When the aircraft is at high altitude, the aperture 31 and door 30 halves are located in a negative pressure area on the fuselage 38 (FIGS. 7-11) such as FIG. 7 where the local low pressure, exerts tremendous pressure upon the door 30. This negative pressure can suck the door 30 completely out of the fuselage 38 if not restrained and causes continual problems with the operation of conventional payload systems.

As a means to negate and thereby overcome the negative aspects of this negative pressure during operation, in the present invention, the door 30 is spring loaded as in FIG. 5, allowing a means for doors 30 to first translate up into the fuselage 38 as in FIG. 8, before translating horizontally to open as in FIG. 9. As those skilled in the art will realize, there are many ways in which to allow for vertical translation of the closed doors 30 as in FIG. 8, and subsequent horizontal translation in opposite directions of the doors 30 as in FIG. 9, in order to open the aperture 31. As such all such means as would occur to those skilled in the art are anticipated within the scope of this invention.

In operation, as the drive motor 35 turns a drive shaft 39 it causes the door 30 to fully enter the fuselage 38 first, and to separate as in FIG. 9 and to open fully. The reverse function to close the door 30 is shown in FIGS. 10-11 wherein the motor drive 35 is reversed to cause the door 30 halves to approach each other, and to drop back into the aperture 31 as in FIG. 10 and lower into the aperture 31 of the fuselage 38 until flush.

With the door 30 in the open position of FIG. 9, and the translation component 11 (FIG. 1) operatively positioned, the mounting plate 22 (FIG. 1) is translated toward the bottom plate 13. The payload 16, shown as a camera, passes through an aperture in the bottom plate 13 and is eventually exposed below the bottom plate 13 and below the fuselage 38 when the door 30 halves are positioned as in FIG. 9. Once finished, reversing the rotation of the motor and engaged actuator screws 20 raises the payload 16 to the stowed position of FIG. 4 and removes it from the aperture 31 allowing for closure of the door 30 halves and translation to a position within the aperture 31 which positions the exterior of the door 30 halves, substantially even with the surface of the fuselage 38 as in FIG. 11 or FIG. 7.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A payload door and elevator system for the translation of a payload such as a camera, from a stowed position within said fuselage, through an aperture in the aircraft fuselage, to a deployed position projecting from said fuselage, comprising:
a translation component operatively mounted in an aligned position with an aperture formed in an aircraft fuselage;
said translation component having mounting plate, said mounting plate translatable engaged between an upper mount and a lower mount;
said mounting configured for an engagement with a payload from a lower surface thereof;
a motor in operative engagement with a rotating actuating screw member;
said actuating screw member operatively engaged with a transfer screw on said mounting plate; and
rotation of said actuating screw causing a translation of said mounting plate to thereby move said payload between said stowed position, through an aperture in said lower mount to said deployed position.

2. The payload door and elevator system of claim 1, additionally comprising:
a pair of door halves positioned within said aperture;
said door halves operatively engaged to said translation component and translatable in a horizontal direction between a closed position sealing said aperture, to an open position allowing passage of said payload through said aperture; and
said door halves moving to said open position prior to said payload moving to said deployed position.

3. The payload door and elevator system of claim 2, additionally comprising:
said door halves engaged to a support maintaining them in said closed position;
said support and said door halves translatable in a vertical direction normal to said horizontal direction;
said door halves translatable a first distance in said vertical direction, prior to any translation in said horizontal direction;
said first distance being a distance exceeding a thickness of said fuselage at said aperture, whereby during movement of said payload to said deployed position, said door halves translate first in said vertical direction, to a position within said fuselage, prior to any translation in said horizontal direction, as a means to mitigate effects of low pressure external to said fuselage upon said door halves.
